(19) United States
(12) Patent Application Publication
(10) Pub. No.: US 2008/0179000 A1
(43) Pub. Date: Jul. 31, 2008

(54) Thermal activation for a heat-sensitive adhesive sheet, thermal activation device, printer, method of sticking a heat-sensitive adhesive sheet, and sticking device

(76) Inventors: Takanori Okayasu, Chiba-shi (JP); Norimitsu Sanbongi, Chiba-shi (JP); Minoru Hoshino, Chiba-shi (JP); Noriyoshi Shoji, Chiba-shi (JP); Yoshinori Sato, Chiba-shi (JP)

Correspondence Address: BRUCE L. ADAMS, ESQ.;ADAMS & WILKS, SUITE 1211, 17 BATTERY PLACE, NEW YORK, NY, 10004, US

(21) Appl. No.: 12/008,291

(22) Filed: Jan. 10, 2008

(30) Foreign Application Priority Data
Jan. 25, 2007 (JP) 2007-015185

(51) Int. Cl. B65C 9/25; B65C 9/40; B65C 9/26; G03G 15/20

(52) U.S. Cl. 156/320; 156/359; 156/358; 156/351; 399/328

(57) ABSTRACT

In a thermal activation method for a heat-sensitive adhesive sheet 2 which has a heat-sensitive adhesive layer 2a on one surface thereof and is to be stuck to an adherend 1, when a surface roughness of the adherend 1 is large, by heating the heat-sensitive adhesive layer 2a with large thermal energy, an adhesive is allowed to easily enter recesses 1a of the adherend. When the surface roughness of the adherend 1 is small, by heating the heat-sensitive adhesive layer 2a with small thermal energy, a viscosity of the adhesive is increased to thereby prevent the heat-sensitive adhesive sheet 2 from sliding and being peeled. The surface roughnesses of the adherends 1 may be classified for each material of the adherends 1, and the classified surface roughnesses may be judged according to each material of the adherends 1 to thereby determine the thermal energy.

### FIELD OF THE INVENTION

The present invention relates to a thermal activation method for a heat-sensitive adhesive sheet, a thermal activation device, a printer, a method of sticking a heat-sensitive adhesive sheet, and a sticking device.

### DESCRIPTION OF THE RELATED ART

Conventionally, a heat-sensitive adhesive sheet used as an adhesive label or the like has a heat-sensitive adhesive layer on one surface thereof. The heat-sensitive adhesive layer is incoherent at room temperature, and when heated, the heat-sensitive adhesive sheet exhibits adherence. The heat-sensitive adhesive sheet may have a recordable layer on the other surface thereof. The heat-sensitive adhesive sheet can be made into an adhesive label with a front surface to be subject to recording and a back surface having adherence, by use of a label printer as disclosed in Patent Document 1 or the like. In general, the label printer includes a recording portion for performing recording on the recordable layer of the heat-sensitive adhesive sheet, and a thermal activation device for heating and thermally activating the heat-sensitive adhesive layer. In addition, Patent Document 2 proposes an automatic sticking device for automatically pressing and sticking a heat-sensitive adhesive layer of the adhesive label thus produced to an adherend.

Further, Patent Document 3 discloses a weighing label printer which can produce an adhesive label in the same manner as in. Patent Documents 1 and 2, and which is attached with a weighing portion for weighing the weight of an adherend, or the gross weight of the adherend and an article to be contained in the adherend in a case where the article to be contained in the adherend exists.

In the structures as disclosed in Patent Documents 1 to 3, the thermal energy for heating the heat-sensitive adhesive layer is constant, and the pressing force for pressing the heated heat-sensitive adhesive layer onto the adherend is also constant.

Meanwhile, Patent Document 4 discloses a structure in which the density of energy to be applied to the heat-sensitive adhesive layer can be changed according to the strength of the adherend so that the adherend is not to be broken when the heat-sensitive adhesive sheet is peeled, in many uses for peeling the heat-sensitive adhesive sheet after being temporarily stuck.

Patent Document 5 discloses a structure in which the thermal energy to be applied to the heat-sensitive adhesive layer can be appropriately changed according to use for the heat-sensitive adhesive sheet, environmental temperature, or temperature of the adherend. With this structure, for example, in a case of producing a label for identifying baggage, which is peeled after being stuck in many cases, it is possible to reduce the thermal energy to thereby reduce an adhesive strength of the heat-sensitive adhesive layer.

In addition, Patent Document 6 discloses a structure in which the thermal energy to be applied to the heat-sensitive adhesive layer can be appropriately changed according to the environmental temperature and the type of an adhesive for the heat-sensitive adhesive sheet.

[Patent Document 1] JP 2001-88814 A

[Patent Document 2] JP 06-127539 A

[Patent Document 3] JP 2005-25089 A

[Patent Document 4] JP 2001-48139 A

[Patent Document 5] JP 2004-53756 A

[Patent Document 6] JP 2004-10710 A

As described above, in Patent Documents 4 and 5, it is mainly intended that, when there is a possibility that the heat-sensitive adhesive sheet is peeled after being temporarily stuck, the thermal energy to be applied to the heat-sensitive adhesive layer is to be changed so that the adhesive strength is reduced to a degree sufficient for peeling the heat-sensitive adhesive sheet or so that the adhesive strength is reduced so as not to break the adherend when the heat-sensitive adhesive sheet is peeled. In addition, Patent Documents 4 to 6 suggest that the thermal energy is to be changed according to the environmental temperature or the temperature of the adherend and the type of the adhesive so as to obtain a large adhesive strength.

However, even when the thermal energy is changed according to the environmental temperature or the temperature of the adherend and the type of the adhesive, satisfactory sticking cannot be performed in some cases merely by changing the thermal energy. Specifically, if it is intended that the heat-sensitive adhesive sheet is to be firmly stuck to the adherend, a large adhesive strength cannot be finally obtained in some cases, and a long period of time (for example, about 10 minutes) for obtaining the large adhesive strength is required in some cases. In the latter case, even when the large adhesive strength is finally obtained, after the heat-sensitive adhesive sheet is stuck to the adherend, the heat-sensitive adhesive is not firmly fixed to the adherend for a long period of time (for example, about 10 minutes) and remains in an easily peelable state. Accordingly, in order to prevent erroneous peeling immediately after the heat-sensitive adhesive sheet is stuck, it is necessary to store the adherend to which the heat-sensitive adhesive sheet is stuck so as not to be in contact with a human body, other items, and the like for a long period of time, which deteriorates a working efficiency.

As described above, the time required for firmly fixing the heat-adhesive sheet to the adherend may become longer as a result of constantly setting the thermal energy to be higher for obtaining the large adhesive strength, and it may be difficult to obtain the large adhesive strength and shorten the time required for fixation at the same time. Conventionally, the cause for such failures has not been sufficiently analyzed, and an effective countermeasure therefor has not been taken. When those failures are to be solved merely by increasing the thermal energy, there arises a problem in that the energy efficiency is lowered while the sufficient effect cannot be always obtained.

### SUMMARY OF THE INVENTION

Therefore, it is an object of the present invention to provide a thermal activation method for a heat-sensitive adhesive sheet, a thermal activation device, a printer, a method of sticking a heat-sensitive adhesive sheet, and a sticking device, which are capable of firmly sticking a heat-sensitive adhesive sheet to an adherend, capable of obtaining a state where the heat-sensitive adhesive sheet is firmly fixed to the adherend at a relatively early stage, and obtaining satisfactory energy efficiency.

The present invention is characterized by providing a thermal activation method for a heat-sensitive adhesive sheet which includes a heat-sensitive adhesive layer on one surface thereof and is to be stuck to an adherend, and characterized in that the heat-sensitive adhesive layer is heated with different thermal energy based on a surface roughness of the adherend. As a result, it is possible to obtain a satisfactory adhesive state of the heat-sensitive adhesive layer to the adherend satisfactory in view of the influence of the surface roughness of the adherend which has not been conventionally focused at all.

In addition, when the heat-sensitive adhesive layer is heated with different energy based on the surface roughness and temperature of the adherend, it is possible to realize a firm adhesive state rapidly in view of the both effects of the surface roughness and the temperature of the adherend.

By classifying the surface roughnesses of adherends for each material of the adherends and judging the surface roughness according to each material of the adherends to determine the thermal energy, it is possible to easily perform control without the need of measuring the surface roughness for each adherend.

Another characteristic of the present invention resides in that a thermal activation device for a heat-sensitive adhesive sheet which has a heat-sensitive adhesive layer on one surface thereof and is to be stuck to an adherend includes: a heating portion for heating the heat-sensitive adhesive layer; and a control portion for controlling the heating portion to change thermal energy to be applied to the heat-sensitive adhesive layer from the heating portion based on a surface roughness of the adherend.

Another characteristic of the present invention resides in that a method of sticking a heat-sensitive adhesive sheet, which includes a heat-sensitive adhesive layer on one surface thereof, with respect to an adherend includes the steps of: heating the heat-sensitive adhesive layer; and pressing the heated heat-sensitive adhesive layer onto the adherend with a different pressing force based on the surface roughness of the adherend. With the structure, it is also possible to obtain a satisfactory adhesive state of the heat-sensitive adhesive layer with respect to the adherend in view of the influence of the surface roughness of the adherend.

Further, it is preferable that the step of pressing the heat-sensitive adhesive layer onto the adherend be performed by pressing the heat-sensitive adhesive layer with a different pressing force based on the surface roughness and temperature of the adherend.

Further, by classifying the surface roughnesses of the adherends for each material of the adherends and determining the pressing force through judgement of the surface roughness according to each material of the adherends, the control can be easily performed.

Another characteristic of the present invention resides in that a method of sticking a heat-sensitive adhesive sheet, which includes a heat-sensitive adhesive layer on one surface thereof, with respect to an adherend includes the steps of: heating the heat-sensitive adhesive layer with small thermal energy irrespective of the surface roughness of the adherend; and pressing the heated heat-sensitive adhesive layer onto the adherend with a large pressing force in a case where the surface roughness of the adherend is large and with a small pressing force in a case where the surface roughness of the adherend is small.

Another characteristic of the present invention resides in that a sticking device for a heat-sensitive adhesive sheet, for sticking the heat-sensitive adhesive sheet including a heat-sensitive adhesive layer on one surface thereof, to an adherend includes: a heating portion for heating the heat-sensitive adhesive layer; a pressing portion for pressing the heated heat-sensitive adhesive layer onto the adherend; and a control portion for controlling the pressing portion to change a pressing force for pressing the heat-sensitive adhesive layer onto the adherend based on the surface roughness of the adherend.

According to the present invention, by controlling thermal energy and/or a pressing force based on a surface roughness of an adherend which has not been conventionally focused, time required for firmly fixing a heat-sensitive adhesive sheet to an adherend can be shortened and a large adhesive strength can be obtained at the same time. In particular, by controlling the thermal energy and/or the pressing force based on the surface roughness and temperature of the adherend, reliability in sticking thereof can be enhanced.

### BRIEF DESCRIPTION OF THE DRAWINGS

In the accompanying drawings:

FIG. 1A is a schematic diagram showing a conventional process for sticking a heat-sensitive adhesive sheet to an adherend having a large surface roughness, and FIG. 1B is a schematic diagram showing a conventional process for sticking a heat-sensitive adhesive sheet to an adherend having a small surface roughness;

FIG. 2 is a schematic diagram showing a process according to the present invention for sticking a heat-sensitive adhesive sheet to an adherend having a large surface roughness;

FIG. 3 is a schematic diagram showing a process according to the present invention for sticking a heat-sensitive adhesive sheet to an adherend having a small surface roughness;

FIG. 4 is a graph showing a relationship between time and an adhesive strength obtained after sticking in a case where the heat-sensitive adhesive sheet is stuck to the adherend by employment of a conventional method;

FIG. 5 is a graph showing a relationship between time and an adhesive strength obtained after sticking in a case where the heat-sensitive adhesive sheet is stuck to the adherend by employment of a first method according to the present invention;

FIG. 6 is a graph showing a relationship between time and an adhesive strength obtained after sticking in a case where the heat-sensitive adhesive sheet is stuck to the adherend by employment of a second method according to the present invention;

FIG. 7 is a schematic diagram showing an internal structure of a printer according to the present invention; and

FIG. 8 is a block diagram showing a main part of the printer shown in FIG. 7.

### DETAILED DESCRIPTION OF THE PREFERRED EMBODIMENT

Hereinafter, an embodiment of the present invention will be described with reference to the drawings.

According an embodiment of the present invention, when a heat-sensitive adhesive sheet 2 having a heat-sensitive adhesive layer 2a is stuck to an adherend 1, thermal energy for thermally activating the heat-sensitive adhesive layer 2a is changed based on a surface roughness of the adherend 1. Alternatively, a pressing force for pressing the heat-sensitive adhesive layer 2a to the adherend 1 is changed based on the surface roughness of the adherend 1. Technical significance thereof will be described below.

First, the background of the present invention achieved by the inventor(s) is described as follows. As described above, conventionally, even when the thermal energy is applied to the heat-sensitive adhesive layer, a large adhesive strength cannot be finally obtained in some cases, or a long period of time (for example, about 10 minutes) for obtaining the large adhesive strength is required in some cases. Accordingly, the inventor(s) has (have) studied on factors of the failures, with the result that it is found that the surface roughness of a surface to be adhered of the adherend is the factor of the failures.

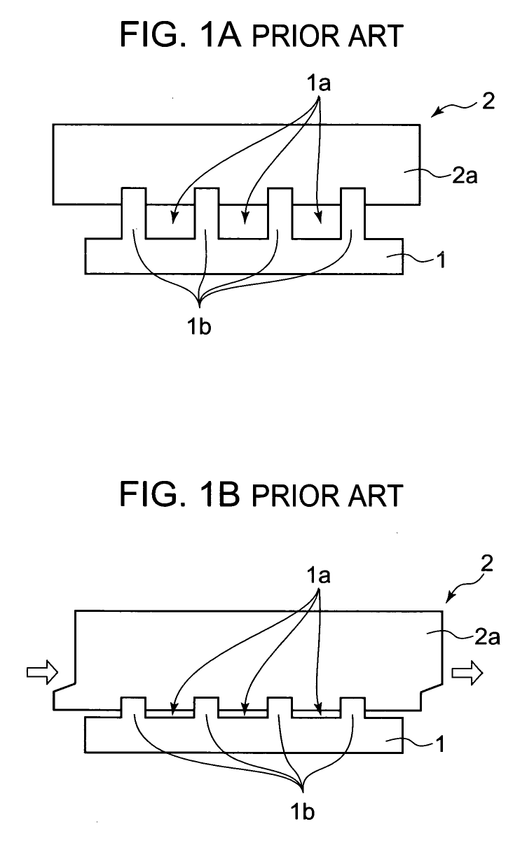

In other words, in a case of pressing the heat-sensitive adhesive sheet 2 which has been activated with thermal energy smaller than optimum thermal energy for sticking to the adherend 1 (for example, corrugated board) having relatively large surface roughness, for example, with thermal energy equivalent to optimum thermal energy for sticking to an adherend (for example, wrap film) whose surface is relatively smooth, to the adherend 1 (for example, corrugated board) having relatively large surface roughness, as enlarged and schematically shown in FIG. 1A, even when the heat-sensitive adhesive layer 2a of the heat-sensitive adhesive sheet 2 is pressed to the adherend 1, there is a possibility that an adhesive for the heat-sensitive adhesive layer 2 is not sufficiently pressed into the recesses la of the surface of the adherend 1. In a state shown in FIG. 1A, when the adhesive is immediately cured, the heat-sensitive adhesive-sheet 2 is fixed only to a part (protrusions 1b) of the surface of the adherend 1, thereby reducing the adhesive strength. That is, a large adhesive strength cannot be obtained.

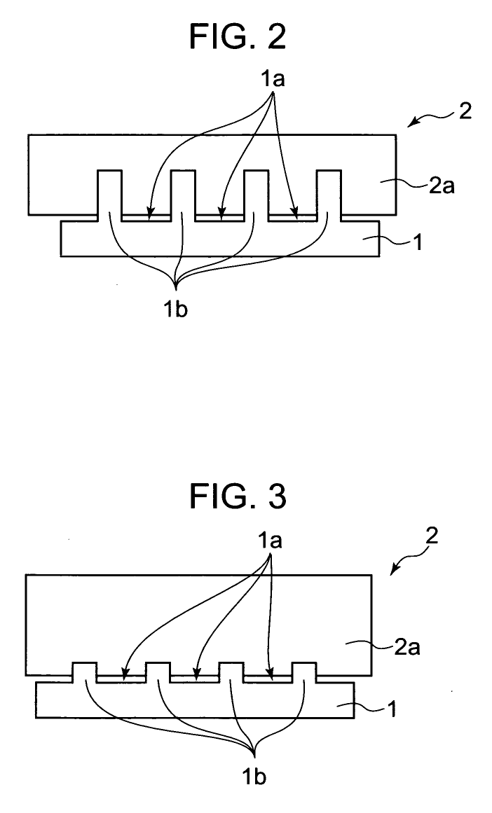

Therefore, according to the present invention, in the case where the surface roughness of the adherend 1 is large, the adhesive for the heat-sensitive adhesive layer 2 is allowed to enter the recesses 1a as shown in FIG. 2.

For example, it is possible that the viscosity of the adhesive is reduced (incohesive state is obtained) by applying large thermal energy to the heat-sensitive, adhesive layer 2a, and time required or curing the adhesive is increased. As a result, the adhesive obtained before being completely cured gradually enters the recesses 1a of the surface of the adherend 1 along the surface of the adherend 1, thereby finally obtaining the large adhesive strength. Note that this method requires a long period of time for fixing the heat-sensitive adhesive sheet 2 to the adherend 1, so the adhesive strength is small for a long period of time before the adhesive is completely cured, which increases the risk that a sticking position for the heat-sensitive adhesive sheet 2 is shifted or the heat-sensitive adhesive sheet 2 is peeled from the adherend 1.

As another example for allowing the adhesive for the heat-sensitive adhesive layer 2a to enter the recesses la of the surface of the adherend 1 as shown in FIG. 2, it is possible to increase a pressing force for pressing the heat-sensitive adhesive layer 2a onto the adherend 1. In this case, by application of a large pressing force, the adhesive is pressed by force into the recesses 1a of the surface of the adherend 1. Thus, even in the case of the heat-sensitive adhesive sheet activated with the thermal energy smaller than the optimum thermal energy with respect to the adherend (for example, corrugated board) having relatively large surface roughness, by sticking with a large pressing force the heat-sensitive adhesive sheet to the adherend (for example, corrugated board) having relatively large surface roughness, the adhesive for the heat-sensitive adhesive sheet 2 can be applied to the entire surface of the adherend 1, thereby finally obtaining the large adhesive strength. In addition, because the thermal energy is relatively small, the time required for curing the adhesive is short, with the result that the risk of shifting the sticking position of the heat-sensitive adhesive sheet 2 or peeling the heat-sensitive adhesive sheet 2 from the adherend 1 can be reduced.

As described above, in this embodiment, in the case where the surface roughness of the surface to be adhered of the adherend 1 is large, by increasing the thermal energy to be applied to the heat-sensitive adhesive layer 2a and by increasing the pressing force for pressing the heat-sensitive adhesive layer 2a onto the adherend 1, satisfactory sticking thereof can be achieved. As a matter of course, only one of the increasing of the thermal energy and the increasing of the pressing force may be carried of, or a combination thereof may be carried out.

On the other hand, as enlarged and schematically shown in FIG. 1B, in the case where the surface roughness of the adherend 1 is small, smooth surfaces are in contact with each other with respect to the heat-sensitive adhesive layer 2a of the heat-sensitive adhesive sheet 2. In particular, when the viscosity of the adhesive is low and the incohesive state is obtained by application of the large thermal energy to the adhesive, there is a fear that the both surfaces are extremely smooth and easily slide, and by application of only a small force, the heat-sensitive adhesive layer 2a is sheared and a part of the heat-sensitive adhesive sheet 2 slides sideways to be peeled.

Therefore, according to the present invention, in the case where the surface roughness of the adherend is small, the thermal energy to be applied to the heat-sensitive adhesive layer 2a is reduced as shown in FIG. 3. Only the small thermal energy is applied to the adhesive, so the viscosity thereof becomes higher and the adhesive becomes sticky. As a result, the possibility that the heat-sensitive adhesive sheet 2 slides on the surface to be adhered of the adherend 1 to be peeled is reduced. In this state, the adhesive is cured before long, and the heat-sensitive adhesive sheet 2 is fixed to the adherend 1. In addition, because the small thermal energy is applied, the time required for curing the adhesive is shortened, thereby reducing the risk of shifting the sticking position of the heat-sensitive adhesive sheet 2 and peeling the heat-sensitive adhesive sheet 2 from the adherend 1.

It should be noted that, in the case where the surface roughness of the adherend 1 is small as described above, the recesses 1a into which the adhesive is to be pressed are small, so a small pressing force for pressing the heat-sensitive adhesive layer 2a onto the adherend 1 may be applied. There is no need to apply an unnecessary large pressing force thereto, thereby saving the energy.

As described above, according to this embodiment, in the case where the surface roughness of the adherend 1 is large, the thermal energy to be applied to the heat-sensitive adhesive layer 2a of the heat-sensitive adhesive sheet 2 is to be increased, the pressing force for pressing the heat-sensitive adhesive layer 2a onto the adherend 1 is to be increased, or both of them is to be carried out. Further, in the case where the surface roughness of the adherend 1 is small, the thermal energy to be applied to the heat-sensitive adhesive layer 2a of the heat-sensitive adhesive sheet 2 is to be reduced, the pressing force for pressing the heat-sensitive adhesive layer 2a onto the adherend 1 is to be reduced, or both of them is to be carried out. As a result, the heat-sensitive adhesive sheet 2 can be preferably stuck to the adherend 1 while avoiding the waste of energy and enhancing the efficiency.

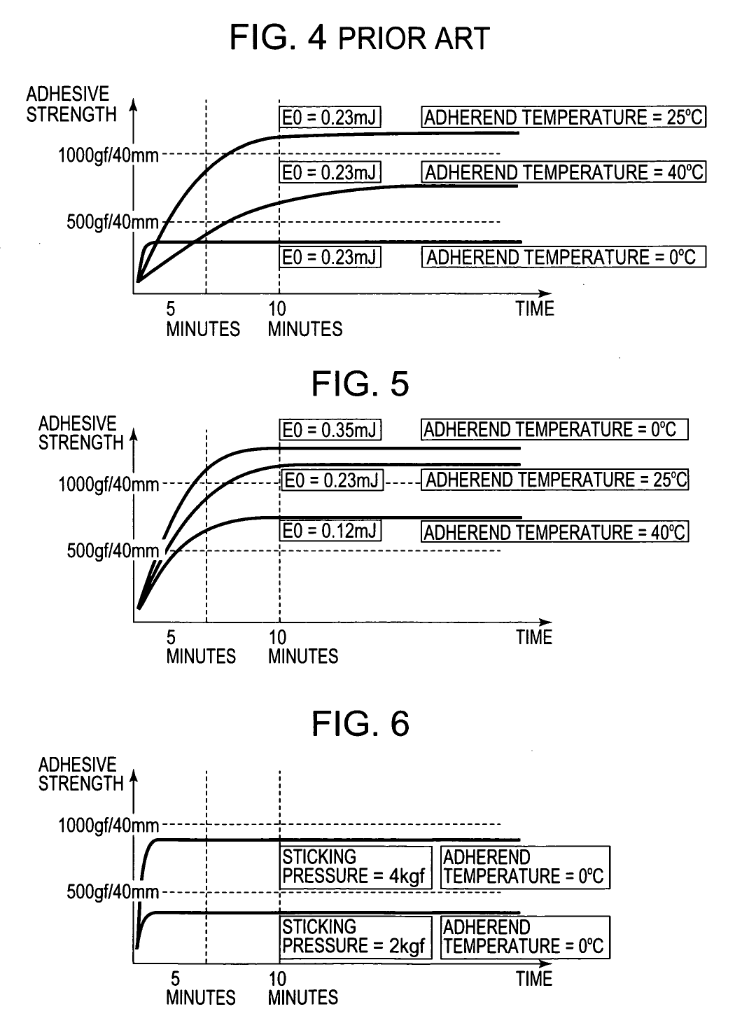

Further, in addition to the surface roughness of the adherend 1, based on temperature of the adherend 1, the thermal energy to be applied to the heat-sensitive adhesive layer 2a of the heat-sensitive adhesive sheet 2 and the pressing force for pressing the heat-sensitive adhesive layer onto the adherend maybe controlled. Specifically, as shown in FIG. 4, in a case where a thermal energy E0 is set to be constant (0.23 mJ) and a pressing force (sticking stress) is set to be constant (2 kgf), when the temperature of the adherend 1 is low (for example, 0° C.), a small adhesive strength is obtained. This is because, as in the case where the surface roughness of the adherend 1 is large as shown in FIG. 1A, the adhesive is cured before the adhesive sufficiently enters the recesses la of the surface of the adherend 1. On the other hand, when the temperature of the adherend 1 is high (for example, 40° C.), a large adhesive strength can be finally obtained. However, the time required for curing the adhesive is long as in the case where the surface roughness of the adherend 1 is small as shown in FIG. 1B. It should be noted that the adhesive strength is represented as a strength required when the heat-sensitive adhesive sheet 2 having a width of 40 mm is peeled by the length 100 mm from the adherend 1.

As shown in FIG. 5, the thermal energy E0 may be increased (for example, increased to 0.35 mJ) when the temperature of the adherend 1 is low, and the thermal energy E0 may be reduced (for example, increased to 0.12 mJ) when the temperature of the adherend 1 is high. As shown in FIG. 6, it is effective to increase the pressing force (for example, increased to 4 kgf) when the temperature of the adherend 1 is low. Although not shown in the figure, when the temperature of the adherend 1 is high, the pressing force has little effect on the adhesive strength despite the magnitude of the pressing force. Accordingly, by reducing the pressing force, the waste of energy can be avoided and the energy efficiency can be enhanced.

As described above, it is effective to detect not only the surface roughness of the adherend 1 but also the temperature thereof to control one of or both of the thermal energy to be applied to the heat-sensitive adhesive layer 2a of the heat-sensitive adhesive sheet 2, and the pressing force for pressing the heat-sensitive adhesive layer 2a onto the adherend 1.

### EXAMPLES

A more specific example of the above-mentioned embodiment of the present invention will be described. The heat-sensitive adhesive sheet 2 used in this example includes a heat-sensitive recordable layer (not shown) on one surface which is the opposite side of the heat-sensitive adhesive layer 2.

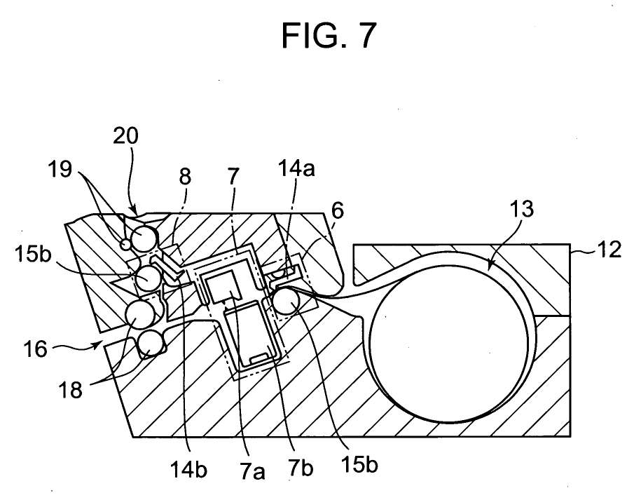

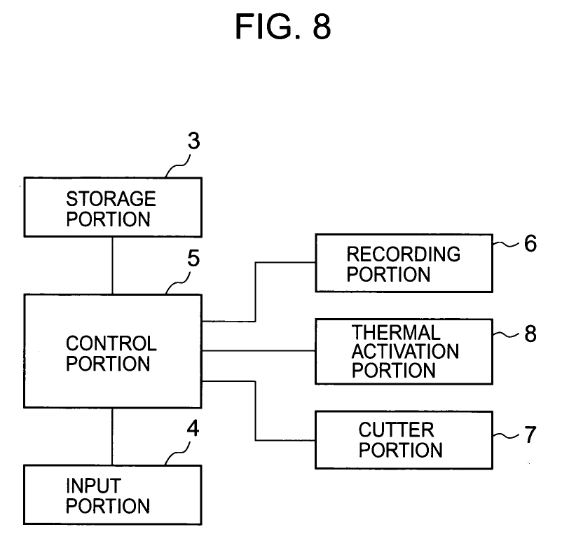

FIGS. 7 and 8 each show an example of a printer according to the present invention. A printer 11 includes a roll containing portion 13, a recording portion 6, a cutter portion 7, and a thermal activation portion 8 which are contained in a casing 12.

The roll containing portion 13 retains a roll 2a of the heat-sensitive adhesive sheet 2 which is continuous form paper so as to be rotatable.

The recording portion 6 is constituted by a recording thermal head 14a for heating the recordable layer of the heat-sensitive adhesive sheet 2 to perform recording thereon, and a platen roller 15a which is a transport mechanism to be brought into press contact with the recording thermal head 14a. The recording thermal head 14a of the recording portion 6 is positioned to be in contact with one surface (recordable layer) of the heat-sensitive adhesive sheet 2 transported from the roll containing portion 13.

The cutter portion 7 is used to cut into a label shape the heat-sensitive adhesive sheet 2 which is continuous form paper whose recordable layer has been subject to recording by the recording portion 6, and is constituted by a pair of cutter members 7a and 7b and the like. It should be noted that the cutter members 7a and 7b are supported by a support member not shown.

The thermal activation portion 8 may have substantially the same structure as that of the recording portion 6, and is constituted by a thermal activation thermal head 14b for heating the heat-sensitive adhesive layer of the heat-sensitive adhesive sheet 2 to be thermally activated, and a platen roller 15b which is a transport mechanism to be brought into press contact with the thermal activation thermal head 14b. The recording thermal head 14a and the thermal activation thermal head 14b may have the same structure, and the platen rollers 15a and 15b may have the same structure. The thermal activation portion 8 is disposed at a curved position from a path for the heat-sensitive adhesive sheet 2 which passes through the recording portion 6 and the cutter portion 7. The thermal activation thermal head 14b is positioned to be in contact with the heat-sensitive adhesive layer 2a of the label-like heat-sensitive adhesive sheet 2 which has been pulled out from the roll containing portion 13, has the recordable layer subjected to recording by the recording portion 6, and which has been cut by the cutter portion 7.

A first outlet 16 is provided at a downstream side of the cutter portion 7, and a pair of transport rollers 18 is disposed between the cutter portion 7 and the first outlet 16. Therefore, the recording portion 6, the cutter portion 7, the pair of transport rollers 18, and the first outlet 16 are linearly aligned. Further, above the thermal activation portion 8, a pair of delivery rollers 19 and a second outlet 20 are provided.

In the printer 11, a control portion 5, a storage portion 3, and an input portion 4 shown in FIG. 8 are provided. The control portion 5 is connected to the thermal heads 14a and 14b, the platen rollers 15a and 15b, and the like to perform drive and control therefor.

An outline of a method of producing an adhesive label by using the printer 11 having the above-mentioned structure is described as follows. First, the heat-sensitive adhesive sheet 2 in a continuous form is pulled out from the roll 2a contained in the roll containing portion 13 and is set in the recording portion 6. Then, a recording signal is supplied to the recording thermal head 14a to perform recording on the recordable layer of the heat-sensitive adhesive sheet 2. In synchronization with the drive for the recording thermal head 14a, the platen roller 15a is rotated, thereby transporting the heat-sensitive adhesive sheet 2.

The heat-sensitive adhesive sheet 2 which is continuous form paper whose recording layer has been thus subject to recording, passes between the cutter members 7a and 7b of the cutter portion 7. When a position for cutting the heat-sensitive adhesive sheet 2 reaches a position facing the cutter members 7a and 7b, the transportation of the heat-sensitive adhesive sheet 2 is temporarily stopped, and the heat-sensitive adhesive sheet 2 is cut into a label shape by the cutter members 7a and 7b (Step S5). Upon completion of the cutting, the heat-sensitive adhesive sheet 2 which has been subject to recording and cut is further transported. Then, a leading edge of the heat-sensitive adhesive sheet 2 protrudes to an outside from the first outlet 16.

Before a trailing edge of the heat-sensitive adhesive sheet 2 is taken out of the pair of transport rollers 18, the transport rollers 18 are reversely rotated, the path for the heat-sensitive adhesive sheet 2 in a label shape is changed, and the heat-sensitive adhesive sheet 2 is transported to the thermal activation portion 8 with the trailing edge thereof being the leading edge. Then, in the thermal activation portion 8, the thermal activation thermal head 14b heats the heat-sensitive adhesive layer 2a to be thermally activated. Then, the thermal activation method according to an embodiment of the present invention is carried out. Specifically, based on the surface roughness of the adherend 1 which has been input in advance from the input portion 4, data stored in the storage portion 3 is referred to and a drive pulse used for the control portion 5 to drive the thermal activation thermal head 14b is determined. In other words, the control portion 5 determines the thermal energy to be supplied from the thermal activation thermal head 14b to the heat-sensitive adhesive layer 2a based on the surface roughness of the adherend 1. It should be noted that the drive pulse which has been appropriately set based on the level of the surface roughness corresponding to the adherend 1 may be stored in the storage portion 3. Then, when not a numerical value itself for the surface roughness of the adherend, but the type of the adherend 1 (for example, a corrugated board having a large surface roughness, and a wrap film made of a polyethylene resin having a small surface roughness) is input from the input portion 4, the control portion 5 determines the drive pulse to be supplied to the thermal activation thermal head 14b which corresponds to the surface roughness of the adherend 1 of the type, that is, the thermal energy to be supplied to the heat-sensitive adhesive layer 2a. The method of controlling the thermal energy is the same as that described as the embodiment of the present invention.

The thermal activation for the heat-sensitive adhesive layer 2a is carried out by the thermal activation portion 8, and at the same time, the platen roller 15b and the delivery roller 18 are rotated to deliver the heat-sensitive adhesive sheet 2 in a label shape (adhesive label) to the outside from the second outlet 20.

With the printer 11 having the above-mentioned structure, the thermal activation for a heat-sensitive adhesive sheet according to the present invention can be realized. Alternatively, the thermal activation device may be constituted by the thermal activation portion 8, the control portion 5, and the storage portion 3, which can be used independently of the recording portion 6 or the like.

Although not shown in the figure, it is possible to employ a sticking device including a pressing member for pressing the heat-sensitive adhesive layer 2a of the heat-sensitive adhesive sheet 2 (adhesive label) delivered from the second outlet 20. The sticking device for a heat-sensitive adhesive sheet may have a structure in which the pressing member is added to the above-mentioned printer 11. In this case, the shape, the position, or the like of the second outlet 20 may be changed as a matter of course, and it is possible to employ a structure in which a transport device such as a belt conveyor is provided in the vicinity of the second outlet 20, and produced adhesive labels are continuously stuck, by the pressing member, to a plurality of adherends 1 that are continuously supplied by the transport device. The pressing member may be used for pressing the heat-sensitive adhesive sheet 2 onto the adherend 1 by blowing air thereto, or may be a member for pressing the heat-sensitive adhesive sheet 2 by directly bringing a bar-like or plate-like member into contact with the heat-sensitive adhesive sheet 2.

Further, the sticking-device may be constituted by the thermal activation portion 8, the control portion 5, the storage portion 3, and the pressing member, which can be used independently of the recording portion 6 or the like.

In those sticking devices, instead of performing the above-mentioned control of the thermal energy based on the surface roughness of the adherend 1, the pressing force by the pressing member onto the adherend 1 of the heat-sensitive adhesive layer 2a of the heat-sensitive adhesive sheet 2 may be controlled. The method of controlling the pressing force may be the same as that described as the embodiment of the present invention. Further, the above-mentioned control of the thermal energy and the control of the pressing force may be performed at the same time.

A temperature sensor (not shown) for measuring the temperature of the adherend may be provided to perform control of the thermal energy and/or the pressing force based on the temperature measured using the temperature sensor.

Further, though not shown in the figure, a weighing portion may be provided to the above-mentioned printer, and the printer may be constituted as a weighing label printer similar to that of Patent Document 3. In this case, a temperature sensor (not shown) for measuring the temperature of the adherend may be provided close to the weighing portion.

What is claimed is:

1. A thermal activation method for a heat-sensitive adhesive sheet, which has a heat-sensitive adhesive layer on one surface thereof, and is to be stuck to an adherend, comprising heating the heat-sensitive adhesive layer with different thermal energy based on a surface roughness of the adherend.

2. A thermal activation method for a heat-sensitive adhesive sheet according to claim 1, further comprising heating the heat-sensitive adhesive layer with different thermal energy based on the surface roughness and temperature of the adherend.

3. A thermal activation method for a heat-sensitive adhesive sheet according to claim 1, further comprising:
classifying the surface roughnesses of the adherends for each material of the adherends; and
determining the thermal energy through judgment of the surface roughness according to each-material of the adherends.

4. A thermal activation device for a heat-sensitive adhesive sheet, which has a heat-sensitive adhesive layer on one surface thereof, and is to be stuck to an adherend, comprising:
a heating portion for heating the heat-sensitive adhesive layer; and
a control portion for controlling the heating portion to change thermal energy to be applied to the heat-sensitive adhesive layer from the heating portion based on a surface roughness of the adherend.

5. A thermal activation device for a heat-sensitive adhesive sheet according to claim 4, wherein the control portion controls the heating portion to change the thermal energy to be applied to the heat-sensitive adhesive layer from the heating portion based on the surface roughness and temperature of the adherend.

6. A thermal activation device for a heat-sensitive adhesive sheet according to claim 4, further comprising a storage portion for classifying the surface roughnesses of the adherends for each material of the adherends to be stored,
wherein the control portion refers to the storage portion to judge the surface roughness of the adherend according to each material of the adherends, and determines the thermal energy according to judgment results.

7. A printer for performing thermal activation for a heat-sensitive adhesive layer and recording on a recordable layer, with respect to a heat-sensitive adhesive sheet including the heat-sensitive adhesive layer on one surface thereof and including the recordable layer on the other surface thereof, comprising:
the thermal activation device for a heat-sensitive adhesive sheet according to claim 4; and
a recording portion for performing recording on the recordable layer.

8. A method of sticking a heat-sensitive adhesive sheet, which includes a heat-sensitive adhesive layer on one surface thereof, with respect to an adherend, comprising the steps of:
heating the heat-sensitive adhesive layer; and
pressing the heated heat-sensitive adhesive layer onto the adherend with a different pressing force based on a surface roughness of the adherend.

9. A method of sticking a heat-sensitive adhesive sheet according to claim 8, wherein the step of pressing the heat-sensitive adhesive layer onto the adherend comprises pressing the heat-sensitive adhesive layer with a different pressing force based on the surface roughness and temperature of the adherend.

10. A method of sticking a heat-sensitive adhesive sheet according to claim 8, further comprising:
classifying the surface roughnesses of the adherends for each material of the adherends; and
determining the pressing force through judgment of the surface roughness according to each material of the adherends.

11. A method of sticking a heat-sensitive adhesive sheet, which includes a heat-sensitive adhesive layer on one surface thereof, with respect to an adherend, comprising the steps of:
heating the heat-sensitive adhesive layer with small thermal energy irrespective of a surface roughness of the adherend; and
pressing the heated heat-sensitive adhesive layer onto the adherend with a large pressing force in a case where the surface roughness of the adherend is large and with a small pressing force in a case where the surface roughness of the adherend is small.

12. A sticking device for a heat-sensitive adhesive sheet, for sticking the heat-sensitive adhesive sheet including a heat-sensitive adhesive layer on one surface thereof, to an adherend, comprising:
a heating portion for heating the heat-sensitive adhesive layer;
a pressing portion for pressing the heated heat-sensitive adhesive layer onto the adherend; and
a control portion for controlling the pressing portion to change a pressing force for pressing the heat-sensitive adhesive layer onto the adherend based on a surface roughness of the adherend.

13. The sticking device for a heat-sensitive adhesive sheet according to claim 12, wherein the control portion controls the pressing portion to change the pressing force for pressing the heat-sensitive adhesive layer onto the adherend based on the surface roughness and temperature of the adherend.

14. A sticking device for a heat-sensitive adhesive sheet according to claim 12, further comprising a storage portion for classifying the surface roughnesses of the adherends for each material of the adherends to be stored,
wherein the control portion refers to the storage portion to judge the surface roughness of the adherend according to each material of the adherends, and determines the pressing force according to judgment results.

15. A sticking device for a heat-sensitive adhesive sheet according to claim 12, further comprising a recording portion for performing recording on a recordable layer provided on the other surface of the heat-sensitive adhesive sheet.
